(19) United States
(12) Patent Application Publication
(10) Pub. No.: US 2015/0223057 A1
(43) Pub. Date: Aug. 6, 2015

(54) SYSTEM AND METHOD FOR COMMUNICATING PROTECTED HEALTH INFORMATION

(71) Applicant: Quick Release Lifescan, LLC, Billerica, MA (US)

(72) Inventors: Richard Dellarciprete, Billerica, MA (US); Eric John Wolotschaj, Tewksbury, MA (US); Michael Dellarciprete, Pflugerville, TX (US)

(21) Appl. No.: 14/605,640

(22) Filed: Jan. 26, 2015

Related U.S. Application Data
(60) Provisional application No. 61/934,411, filed on Jan. 31, 2014.
(60) Provisional application No. 62/087,469, filed on Dec. 4, 2014.

(51) Int. Cl. H04W 12/02; G06F 21/62; G06F 21/60; G06F 19/00

(52) U.S. Cl. CPC H04W 12/02; G06F 19/322; G06F 21/6245; G06F 21/60

(57) ABSTRACT

A method, system and apparatus for securely, rapidly, reliably and automatically transforming machine-readable data that is coupled to a patient into a user-interpretable provision of protected health information, utilizing an intermediate transformation of the machine-readable data into a unique patient identification string associated with the patient and with the protected health information, and subject to the constraint that the machine-readable data is proximal to the mobile hardware device capable of reading the data.

### CROSS-REFERENCE TO RELATED APPLICATION(S)

This application claims priority to, and the benefit of, co-pending U.S. Provisional Application No. 61/934,411, filed on Jan. 31, 2014, and U.S. Provisional Application No. 62/087,469, filed on Dec. 4, 2014, for all subject matter contained in said applications common to the present application. The disclosures of said applications are hereby incorporated by reference in their entirety.

### FIELD OF THE INVENTION

The present invention relates to a medical identification (ID) marker suitable for providing medical personnel with multiple redundant methods for obtaining a protected health information in unique ways. In particular, the present invention incorporates a marker that provides access to protected health information through a scan, provides information to lookup the protected health information, and/or provides a subset of some of the protected health information on the marker itself.

### BACKGROUND

Generally, conventional medical ID tags are used to help medical personnel obtains vital information about a patient in a quick and efficient manner. While such conventional medical ID tags can assist medical personnel to obtain vital information, the information that is able to be placed on a medical ID tag is limited. In particular, a number of conventional devices have been designed to relay sensitive information to an emergency responder. These conventional devices can include medical ID bracelets, wallet cards and medical flash drives. However, these conventional devices have a number of shortcomings. For example, conventional devices, such as a bracelet with words identifying a medical condition, generally display information about the patient so that it is readily visible and interpretable to any onlooker without aid of any device. Other conventional devices, such as a medical flash drive, require a physical hardware interface between the patient device and emergency responder equipment, and are not easily transported or easily identifiable by an emergency responder, especially if the patient is incapable of communicating with the first responder. In addition, to the use of a physical interface can introduce incompatibilities between equipment and, as with certain electronic interfaces, malware onto emergency equipment and systems.

More sophisticated devices for communicating and/or tracking information about an asset or person incorporate wireless communications technologies. However, current wireless devices have not achieved secure, robust, reliable, and private communication of sensitive protected health information about a patient using a device that does not offer data services and/or at a location in which data or cellular services are sporadic, busy, frequently interrupted, or lacking. Additionally, there are no systems that communicate protected health information from a remote source to an on-location emergency responder that can circumvent the need for the patient and/or the emergency responder to direct the process and engage manually with the device. For example, conventional systems use manual, slow and error-prone entry of data into a device in order to access, select and initiate transfer of critical information to them, and may further require a password or other authentication or authorization process that requires input from the patient, which could be difficult to obtain in an emergency situation. Accordingly, these conventional systems may not provide sufficient information, may lack privacy, may cause unnecessary delays and/or errors when retrieving protected health information during an emergency.

### SUMMARY

There is a need for a device, system and method for securely, privately, rapidly and reliably securing for emergency responders critical personal and/or medical information (as a subset of protected health information) about a patient in need of assistance. There is a need to secure this information with minimal instruction, data entry, and/or direction from either the patient or the emergency responder. There is also a need for a device, system and method for providing standard robust operation across various hardware, software, and communications platforms, without direction from the emergency responder, so as to automatically determine and/or distribute the critical personal and/or medical information to the emergency responder in a timely manner. There is a further need for such a system to additionally provide access to protected health information in more detail (such as, including access to the patient's complete medical record), but only upon execution of an authentication and/or authorization step involving the patient. The present invention is directed toward further solutions to address these needs, in addition to having other desirable characteristics.

In accordance with an example embodiment of the present invention, a method of communicating a first subset of protected health information of a patient to a mobile hardware device includes user utilizing a scanning hardware and software of the mobile hardware device to capture a machine-readable data from a marker. The method includes an application stored and executing on the mobile hardware device and the application receives the machine-readable data from the marker and transforms the machine-readable data into a unique patient identification string associated with the machine-readable data. The application also initiates an outgoing text message and places the unique patient identification string into the outgoing text message. The outgoing text message is output from the mobile hardware device to a remote server. The mobile hardware device receives back an automatically generated incoming text message, telephone call, or both, based on the unique patient identification string contained in the outgoing text message. The incoming text message, telephone call, or both, contain the first subset of protected health information associated with the unique patient identification string. The protected health information includes emergency response health information, patient identification information, and patient medical information. The first subset of protected health information includes emergency response health information, patient identification information, or both. A second subset of protected health information includes patient medical information. The method is completed without requiring real-time active authorization from the patient.

According to aspects of the present invention, the application receives information from the mobile hardware device indicating whether there is a cellular communication signal, a Wi-Fi signal, a Miracast signal, a data connection, or combinations thereof. According to further aspects of the present invention, when there is a data connection available, the application includes in the outgoing text message a request for a uniform resource locator (URL) address accessible by the mobile hardware device to convey the first subset of protected health information. According to other aspects of the present invention, when there is no data connection available, the application includes in the outgoing text message a request for a text message, a telephone call, or both. According to aspects of the present invention the application is updated with information indicating a preferred spoken language setting for the mobile hardware device. According to further aspects of the present invention, the application includes in the outgoing text message an indication of a preferred spoken natural language. According to other aspects of the present invention, the incoming text message, telephone call, or both, are implemented in a preferred spoken natural language indicated by the application or the mobile hardware device. According to aspects of the present invention, the unique patient identification string includes an alpha-numeric string. According to further aspects of the present invention, the unique patient identification string maintains patient anonymity by not containing a combination of string characters that is perceivable by a human to on-its-face convey patient identifying information, in such a way that the unique patient identification string is non-human readable. According to other aspects of the present invention, the machine-readable data is disposed on or in a tattoo, necklace, pendant, or bracelet of the patient.

According to aspects of the present invention, the machine-readable data is disposed on or in a bracelet, a capsule, a tag, a band, a wallet identification card, a medical an identification card, or another wearable and/or injectable article of the patient. According to further aspects of the present invention, the machine-readable data is stored in an injectable NFC capsule or a microchip. According to other aspects of the present invention, the incoming text message further includes a uniform resource locator (URL) address accessible by the mobile hardware device to obtain the first subset of protected health information. According to aspects of the present invention, the incoming text message, telephone call, or both, being received by a second mobile hardware device. According to further aspects of the present invention, the scanning hardware and software includes one or more of an optical scanning device, an optical reader, a pen-type reader, a laser scanner, a charge-couple device (CCD) reader, a camera-based reader, a large field-of-view reader, an omni-directional bar) code data scanner, a cellular telephone camera, a smartphone, a near field communication (NFC) reader, a radio frequency identification (RFID) reader, and/or combinations thereof. According to other aspects of the present invention, the machine-readable data includes one or more of characters, symbols, images, patterns, radio frequency transmitted data including RFID and NFC transmitted data, and/or combinations thereof.

According to aspects of the present invention, the first subset of protected health information associated with the unique patient identification string includes one or more databases that stores the first subset of protected health information linked with the unique patient identification string, and wherein providing the one or more databases with the unique patient identification string results in presentation of the first subset of protected health information. According to further aspects of the present invention, the presentation of the first subset of protected health information includes one or more of a display of the first subset of protected health information, provision of a record number required for obtaining the first subset of protected health information from another source, or provision of a clickable hyperlink to the first subset of protected health information. According to other aspects of the present invention, the machine-readable data includes one or more of a bar code, a quick response (QR) code, a matrix code, a plurality of symbols, an image code, an optically scannable code, data conveyed by near field communication, data conveyed by radio frequency, and/or combinations thereof. According to aspects of the present invention, the outgoing text message includes an instruction to send the first subset of protected health information to a second device. According to further aspects of the present invention, the unique patient identification string is stored in an encrypted format, and wherein a database that stores the unique patient identification string is encrypted with 256-bit advanced encryption standard (AES) encryption.

According to an example embodiment of the present invention a method of communicating protected health information of a patient, The method includes a server receiving a request for protected health information including a first subset of protected health information or a second subset of protected information, the request containing a unique patient identification string, wherein the protected health information includes emergency response health information, patient identification information, and patient medical information, the first subset of protected health information includes the emergency response health information, the patient identification information, or both, and the second subset of protected information includes the patient medical information. The server accesses a database that stores the unique patient identification string in association with the protected health information. The server also obtains the protected health information stored in association with the unique patient identification string. The server further determines which subset of the protected health information is requested. The server also causes the automated outputting of a text message, a telephone call, or both, containing the first subset of protected health information associated with the unique patient identification string, or the server receiving patient authorization and outputting data containing the second subset of protected health information.

According to aspects of the present invention, the request for protected health information further includes a request for a uniform resource locator (URL) address accessible to convey the protected health information. According to further aspects of the present invention, the request for protected health information further includes an indication of a preferred spoken language setting for conveyance of the protected health information. According to other aspects of the present invention, the text message, the telephone call, or both, are implemented in a preferred spoken natural language indicated by the request for protected health information. According to aspects of the present invention, the unique patient identification string includes an alpha-numeric string. According to further aspects of the present invention, the unique patient identification string maintains patient anonymity by not containing a combination of string characters that is perceivable by a human to on-its-face convey patient identifying information, in such a way that the unique patient identification string is non-human readable. According to other aspects of the present invention, the request for protected health information includes a uniform resource locator (URL) address accessible by a mobile hardware device to obtain the protected health information.

According to aspects of the present invention, the request for protected health information includes an instruction to send the protected health information to a second device. According to further aspects of the present invention, the database is encrypted with 256-bit advanced encryption standard (AES) encryption. According to other aspects of the present invention, the database that stores the unique patient identification string in association with the protected health information includes one or more databases that store protected health information linked with the unique patient identification string, and wherein providing the one or more databases with the unique patient identification string results in presentation of the first subset of protected health information or the second subset of protected health information. According to aspects of the present invention, the presentation of the first subset of protected health information or the second subset of protected health information includes one or more of a display of protected health information, provision of a record number required for obtaining protected health information from another source, or provision of a clickable hyperlink to protected health information.

According to further aspects of the present invention, the determining which subset of protected health information is requested further includes determining a level of authorization needed to access the second subset of protected health information. According to other aspects of the present invention, the level of authorization for the second subset of patient medical information requires real time authorization from the patient. According to aspects of the present invention, sending a request for authorization for access to the second subset of protected health information to the patient, receiving the authorization from the patient for access to the second subset of protected health information, and granting access to the second subset of protected health information. According to further aspects of the present invention, the authorization includes receipt of at least one of a password and a personal identification number (PIN).

### BRIEF DESCRIPTION OF THE FIGURES

These and other characteristics of the present invention will be more fully understood by reference to the following detailed description in conjunction with the attached drawings, in which:

FIG. 1 is an illustrative environment for implementing the steps in accordance with the aspects of the invention;

FIG. 2A is a diagrammatic illustration of a method for conveying patient-specific medical information to an emergency responder, according to one embodiment of the present invention;

FIG. 2B is a diagrammatic illustration of a method for conveying patient-specific medical information to an emergency responder, according to one embodiment of the present invention;

FIG. 2C is a diagrammatic illustration of a system for conveying patient-specific medical information to an emergency responder, according to one embodiment of the present invention;

FIG. 2D is a diagrammatic illustration of a system configured to convey patient-specific medical information to an emergency responder, according to one embodiment of the present invention;

FIG. 2E is a diagrammatic illustration of a system configured to convey patient-specific medical information to an emergency responder, according to one embodiment of the present invention;

FIG. 3 is a flow chart illustrating a method for transforming a machine-readable data on a marker to an incoming message conveying user'audible and/or visible medical information on an emergency responder's device, according to aspects of the present invention; and

FIG. 4 is a diagrammatic illustration of a high level architecture for implementing processes in accordance with aspects of the invention.

FIG. 5 is a diagrammatic illustration of a high level architecture for implementing processes in accordance with aspects of the invention.

### DETAILED DESCRIPTION

An illustrative embodiment of the present invention relates to a device, system and method by which an emergency responder utilizes a mobile hardware device to obtain sensitive protected health information in the form of emergency response health information and patient identification information about a specific patient securely, rapidly, and reliably, from a single medical identification (ID) marker. Advantageously, the emergency response health information can be obtained without the need for patient participation in identifying where the emergency response health information exists, or the location of a device (such as a flash drive in a pocket of their clothing) on their person. Additionally, there is a need for the same medical ID marker to also provide access to more comprehensive protected health information in the form of patient medical information (e.g., including but not limited to a patient's full protected health records and official medical records), upon execution of an additional authentication and/or authorization step by the patient.

The system is configured with multiple levels of independently operable functional redundancies for obtaining sensitive protected health information from the remote server. Advantageously, in emergency-type situations, the system does not rely on a patient nor on a patient's mobile device for communication with a remote server storing the sensitive protected health information in the form of emergency response health information. Similarly, the system may be configured to convey the emergency response health information directly to a user, such as an emergency responder. The system includes use of a portable device, such as a mobile hardware device, proximal to and/or accessible to an emergency responder. The mobile hardware device is configured to automatically identify, select, and access an available communication signal (or channel) by which to automatically request and receive the emergency response health information. The software application, which may be executing on the mobile hardware device, obtains machine-readable data from a medical ID marker on or associated with the body of the patient, transforms the machine-readable data into a unique patient identification string, which is then transformed into emergency response health information conveyed by at least one conveyance interface to the emergency responder via his/her mobile hardware device.

The medical ID marker may provide an emergency responder or other medical personnel with important emergency response health information to assist in evaluating a patient's medical condition via their mobile hardware computing device. For example, the medical ID marker may provide information for obtaining the emergency response health information related to the patient's past and present medical conditions, preexisting medical conditions, prescriptions/medications, blood type, religious preference, date of birth, language(s), allergies, medical images (e.g., X-Ray, EKG, MRI, etc.), insurance provider/plan, preferred hospital, emergency contact, primary doctor contact information, and any contagious diseases the patient may have contracted. As would be appreciated by one of skill in the art, the medical ID marker may also include patient identification information for identifying the patient. For example, it may include a patient's first name, last name, photo, dental records, DNA, and other identifying traits (e.g., tattoos, birthmarks, scars, etc.). In accordance with example embodiments, system and the medical ID marker may convey the emergency response health information through the multiple levels of independently operable functional redundancies. For example, the multiple levels of redundancy may include a Quick Response Code (QR code), a unique identifier associated with the patient, a Near Field Communication (NFC) chip, an automated call back system, a laser etched text conveying important information (e.g., serious medical conditions or identification), etc.

In an exemplary example embodiment, at the scene of the accident/incident the emergency responder (e.g., paramedic or nurse) who is attending to a patient may use a mobile hardware device (for illustrative purposes, this could include, but not be limited to, a hand held scanner or a smart phone) to capture and/or scan the machine-readable code printed on the medical ID marker. The scanning of the machine-readable code causes a service provider website to automatically load on the mobile hardware device, which provides the emergency response health information for that patient. Alternatively, in some example embodiments, if a hand held scanner or a smart phone is not available to the emergency responder, the medical ID marker includes the patient's unique identifier number which may be used to obtain the emergency response health information that is stored on record for the patient. For example, the emergency responder may call a service provider, enter or vocalize the unique identifier, and receive an automated response with the emergency response health information associated with the unique identifier. Similarly, the first responder may visit the service provider's website and manually enter the unique ID from the medical ID marker to obtain the emergency response health information of the patient. In accordance with example embodiments, a NFC dot (or other wireless communication technology) that is affixed to or otherwise included within the medical ID marker may be used to initiate an immediate bump transfer of the emergency response health information. For example, the first responder may use a hand held scanner or a smart phone to receive the information automatically from the NFC dot.

In accordance with example embodiments, in the event of insufficient mobile coverage (e.g., 3G, 4G, LTE, etc.) to conduct a telephone call, an automated call back system may be initiated to provide emergency response health information. A determination is made by the automated call back system as to the quality of mobile coverage and which types of telecommunication(s) are possible. Accordingly, based on the mobile coverage, the automated call back system may determine the appropriate form of communication to use when transmitting protected health information. For example, if a mobile hardware device has insufficient signal to reliably communicate by voice, a data message (including but not limited to SMS) may be transmitted to the user. As would be appreciated by one of skill in the art, the automated call back system may transmit protected health information over voice channels, data channels, or both. Additionally, in response to a failed attempt to contact the service provider and/or the remote server, the automated call back system can automatically recognize the phone number that tried to access the protected health information from the medical ID marker and will automatically call that number back and give a verbal account of the profile that is on file with the service provider.

Lastly, basic emergency response health information with brief description of the most relevant medical information in an emergency situation may be laser etched as a part of the marker. As would be appreciated by one of skill in the art, the service provider may provide the desired information using the redundant technologies of the present invention for a periodic fee.

In accordance with example embodiments of the present invention, the protected health information provided in response to accessing the marker may vary based on the circumstance and the user(s) requesting the access. In emergency response situations in which an emergency responder uses a mobile hardware device to scan or enter information from the medical ID marker may be provided with a subset of the patient's full protected health information. Accordingly, the emergency response health information subset is provided in emergency response situations and includes the subset of protected health information that would be useful to the emergency responder (i.e., the emergency response health information). For example, the emergency response health information may be information entered into the patient's medical profile (e.g., allergies, medications, or other information that the patient determined is important) such that the patient preemptively authorizes that the emergency response health information to be accessible via the medical ID marker. Additionally, the patient identification information subset may also be entered by the patient into their emergency response health information profile such that the patient preemptively authorizes that the patient identification information to be accessible via the medical ID marker. In accordance with example embodiments, the emergency response health information and the patient identification information may be accessed by scanning the code on the medical ID marker. As would be appreciated by one of skill in the art, scanning the code may provide the emergency response health information and the patient identification information directly to the mobile hardware device or through interaction with the cloud server. Accordingly, the emergency response health information and the patient identification information may be sent back “automatically” to a request from, e.g., an emergency responder, for the information from their mobile device. Similarly, the most crucial subset of this information could be laser etched in recognizable words viewable on the marker (i.e., name, high blood pressure, diabetes, etc.).

In accordance with example embodiments, the patient medical information subset may only be provided to authorized personnel (e.g., doctors, surgeons, etc.). The patient medical information may include a patient's complete official protected health record, including that which is protected by HIPPA and other privacy laws. The patient's official protected health record may be managed by a national standard, stored in virtual location, and/or accessed using a third party site that hosts private protected health records (e.g., an illustrative and non-limiting example is Google Health). As would be appreciated by one of skill in the art, the patient medical information requires additional authorization to access. For example, the user scans the marker code to get a unique patient identification string, and in attempting to access the remote data (containing the patient medical information) the patient (not necessarily the user) has to enter a PIN number or code to authenticate and authorize access to the patient medical information. As would be appreciated by one of skill in the art, the authorization may be utilized in a hospital or doctor's office setting. Accordingly, access to the patient medical information may be accessed using secure hospital computing systems (e.g., laptop, desktop, using an optical scanner connected by USB, etc.).

As utilized herein, the phrase “protected health information” is intended to include all forms and types of information that could be relevant to the health and well-being of a person. The protected health information includes subsets of information in the form of “emergency response health information”, “patient identification information”, and “patient medical information”. As utilized herein, the phrase “emergency response health information’ is intended to include information that would be most relevant and important to provide to an emergency responder attempting to help an individual in need of emergency medical treatment. The emergency response health information includes, but is not limited to, related to the patient's past and present medical conditions, preexisting medical conditions, prescriptions/medications, blood type, religious preference, date of birth, language(s), allergies, medical images (e.g., X-Ray, EKG, MRI, etc.), insurance provider/plan, preferred hospital, emergency contact, primary doctor contact information, and any contagious diseases the patient may have contracted, and the like. However, the emergency response health information is not the patient's complete and full medical history and/or official medical record. As utilized herein, the phrase “patient identification information” includes, but is not limited to, a patient's first name, last name, photographic image, dental records or images, DNA characteristics, fingerprint records, retinal scan information, and/or other identifying traits (e.g., tattoos, birthmarks, scars, or the like, which can be used to identify the patient and/or communicate with the patient. As utilized herein, the phrase “patient medical information” includes, but is not limited to, a patient's complete medical history, including official medical record and/or records stored in services such as Google Health or the like, and which includes the most comprehensive record available for the patient concerning their health and wellbeing. Throughout the present application the above four phrases are utilized in the description of the present invention, and in some cases are utilized in conjunction with examples of what is meant by the phrase in the context of the particular example embodiment being described. Such example lists are not intended to be limiting of the general meaning of these phrases as described above, as would be appreciated by those of skill in the art.

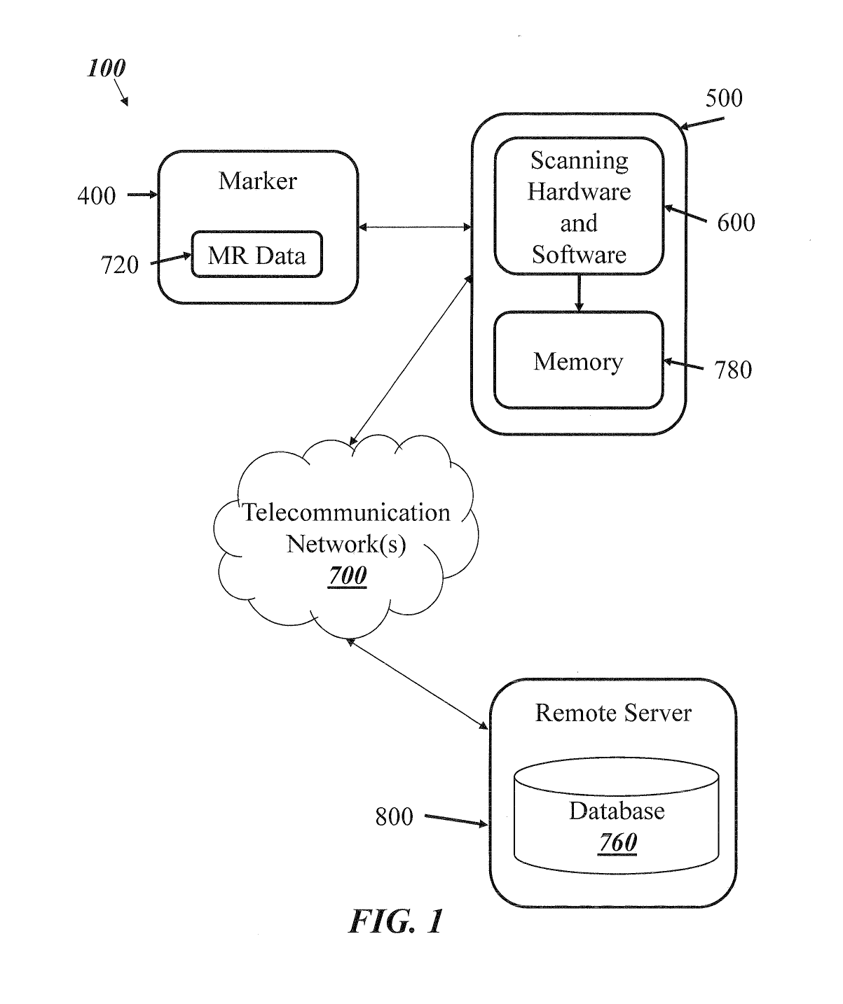

FIGS. 1 through 4, wherein like parts are designated by like reference numerals throughout, illustrate an example embodiment or embodiments of a system and method for communicating protected health information through the use of a medical ID marker, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, style, color, or type of elements or materials, in a manner still in keeping with the spirit and scope of the present invention.

FIG. 1 depicts a high level architecture of implementing processes in accordance with aspects of the present invention. Specifically, FIG. 1 depicts a computing system 100 including a mobile hardware device 500. The mobile hardware device 500 may be a general purpose computer or a specialized computer system. For example, the mobile hardware device 500 may include a single computing device, a collection of computing devices in a network computing system, a cloud computing infrastructure, or a combination thereof. For example, the mobile hardware device 500 may be a mobile computing device, such as a smartphone, a tablet, a laptop, personal digital assistant (PDA) or other mobile computing device. Additionally, the mobile hardware device 500 may be a dedicated scanning device or may include hardware dedicated to scanning (e.g., an optical or wireless communication device) for performing aspects of the present invention. As would be appreciated by one of skill in the art, the mobile hardware device 500 includes a memory 780 for storing data in accordance with example embodiments of the present invention. For example, memory 780 may be Random Access Memory (RAM), Solid State Drive (SSD), flash memory, etc.

In accordance with an example embodiment, the mobile hardware device 500 may include or be connected to a combination of scanning hardware and software 600 for reading machine-readable data 720 from a remote source. For example, the scanning hardware and software 600 is configured to scan, receive, analyze, and/or obtain the machine-readable data 720 from a marker 400 (e.g., medical ID marker). According to aspects of the present invention, the scanning hardware and software 600 may include one or more of an optical scanning device, an optical reader, a camera, a pen-type reader, a laser scanner, a charge-couple device (CCD) reader, a camera-based reader, a large field-of-view reader, an omni-directional bar code data scanner, a cellular telephone camera, a smartphone, a near field communication (NFC) reader, a radio frequency identification (RFID) reader, Bluetooth reader, or a combinations thereof.)

In accordance with example embodiments, the mobile hardware device 500 may use the scanning hardware and software 600 as a barcode reader configured to scan, read, and/or analyze various 2 dimensional and 3 dimensional barcode standards (e.g., Universal Product Code (UPC), Quick Reference (QR) code, data matrix, SKU, etc.). For purposes of the disclosure the mobile hardware device 500 will be described as including the hardware and software 600 for reading and analyzing a machine-readable code, but it is not intended to limit the present invention to the use of a machine-readable code. According to aspects of the present invention, the machine readable data 720 may be included within the marker 400 through one or more of characters, symbols, barcodes, images, patterns, or data conveyed radio frequency transmitted data including RFID, Bluetooth, WI-FI, and NFC transmitted data, and/or combinations thereof. As would be appreciated by one of skill in the art, the mobile hardware device 500 may include a combination of the scanning hardware and software 600 to obtain the protected health information from the marker 400. For example, the mobile hardware device 500 may obtain the machine-readable data 720 from the marker 400 comprising an NFC chip using wireless communication hardware and software 600. Accordingly, the mobile hardware device 500 may be configured to use the scanning hardware and software 600 to read, analyze, or otherwise obtain machine-readable data 720 to obtain protected health information (e.g., emergency response health information, patient identification information, and patient medical information) from a marker 400 (e.g., medical ID marker).

Continuing with FIG. 1, the marker 400 may be an agent capable of conveying information to the mobile hardware device 500. For example, the marker 400 may be a wearable device (e.g., necklace, anklet, pendant, bracelet, capsule, tag, band, wristband, etc.). Alternatively, the marker may be an object attached to or held by the patient (e.g., a tattoo, a token, a wallet ID card, microchip or implantable device that can be implanted under a patient's skin, etc.). The information may be conveyed by the marker 400 through the use of a machine-readable code laser etched onto the marker 400. The mobile hardware device 500 may be able to use the information obtained from the scanned machine-readable data 720 to gather protected health information about the patient in possession of the marker 400. For example, the mobile hardware device 500 may use the machine-readable data 720 received from the marker 400 to contact a remote server 800 to request the protected health information associated with the machine-readable data 720. Alternatively, the mobile hardware device 500 may receive the protected health information directly from the machine-readable data 720 of the machine-readable code. For example, a machine-readable QR code can store up to, e.g., about 4296 alpha-numeric characters. Accordingly, a QR code may store critical emergency response health information and a URL address for accessing a patient's full patent medical information directly on the marker. Advantageously, the use of the QR code may provide an emergency responder with critical information without requiring connecting to the remote server 800, unless additional protected health information is desired.

In accordance with an example embodiment, and briefly discussed above herein, the mobile hardware device 500 may use the information scanned from a machine-readable code to request protected health information from another computing device over a telecommunication network(s) 700. As would be appreciated by one of skill in the art, the telecommunication network(s) 700 may include any combination of known networks. For example, the telecommunication network(s) 700 may be combination of a mobile network, WAN, LAN, or other type of network. In accordance with example embodiments, the telecommunication network(s) 700 may be used to exchange data between the mobile hardware device 500 and the remote server 800 to carry out the functions of the present invention. The remote server 800 may facilitate providing any protected health information not directly provided by the marker 400 to the mobile hardware device 500. For example, the remote server 800 may act as an intermediary layer for gathering protected health information from a database 760. As would be appreciated by one of skill in the art, the remote server 800 may be a single computing device, a collection of computing devices in a network computing system, a cloud computing infrastructure, or a combination thereof, and may compromise the database 760. For example, the remote server 800 and/or the any one of a plurality of servers may reside within the cloud infrastructure or at a physical location at the hospital or another site that serves a medical establishment such as a hospital.

Continuing with FIG. 1, the protected health information may retrieved from the database 760 connected to or otherwise in communication with the remote server 800. As would be appreciated by one of skill in the art, the database 760 may partition the protected health information into one or more subsets, such that access may be restricted to certain situations for particular personnel. For example, the database may partition the protected health information into subsets for emergency response health information, patient identification information, and patient medical information. The emergency response health information may include a subset of the protected health information that is critical for an emergency responder to treat a patient (e.g., blood type, allergies, etc.). The patient identification information subset may include protected health information that includes identification information of the patient (e.g., name, address, emergency contacts, etc.). As would be appreciated by one of skill in the art, each subset may be customized by the holder of the marker 400 and managed in the patient's medical profile. In contrast, the patient medical information may include the patient medical information of a patient (such as a patient's complete medical history and official medical record) and may be restricted according to HIPPA guidelines or other privacy laws (e.g., only accessible from a doctor's office in hospital's secure network). The patient may create a medical profile upon purchase of the medical ID marker and subsequently update and/or select which protected health information and subset(s) of the protected health information is accessible to what personnel and under what circumstances (e.g., authorization). In accordance with an embodiment of the present invention, the unique patient identification is encrypted with 256-bit advanced encryption standard (AES) encryption in the database 760. Advantageously, the unique patient identification may be used to bring up the patient's protected health information from any location that the patient is located.

In operation, the system 100 may be used to carry out the functions of the present invention. Specifically, the combination of the mobile hardware device 500 and the scanning hardware and software 600 may be used to scan, read, capture, or otherwise obtain machine-readable data 720 stored on or within the marker 400. Once the machine-readable data 720 is obtained from the marker 400, the mobile hardware device 500 may store the machine-readable data 720 in memory 780 for analysis and transformation. In particular, the mobile hardware device may analyze the machine-readable data 720 for any information (e.g., the remote server address) needed to request protected health information or subset(s) thereof from a remote server. Additionally, the mobile hardware device 500 may also transform at least a portion of the machine-readable data 720 into a unique patient identification string 740. Advantageously, the unique patient identification string 740 maintains patient anonymity by not containing a combination of strings and/or characters that are perceivable by a human to, on-its-face, convey patient identifying information, in such a way that the unique patient identification string is non-human readable. The unique patient identification string 740 may be included in an outgoing data message addressed to the remote server 800 over an available telecommunication network(s) 700. As would be appreciated by one of skill in the art, the remote server 800 address may be known by the application on the mobile hardware device 500 or the address may be discovered by the application during the analysis of the machine-readable data 720.

In accordance with example embodiments, the mobile hardware device 500 and/or the software application executing on at least one processor of the mobile hardware device 500 are configured to automatically detect functional (open and active, and/or available) telecommunication network(s) 700 channels. As would be appreciated by one of skill in the art, a determination of optimal reception of data (for example, the optimal mode and/or means by which data is received) can also be determined by the software application on the mobile hardware device 500. For example, the software application may determine whether there is a cellular communication signal, a Wi-Fi signal, a Miracast signal, a data connection, or combinations thereof. When there is a data connection available, the software application can transmit the outgoing data message requesting the protected health information or requesting a hyperlink for displaying the protected health information, or subsets thereof, to the remote server 800. For example, the software application may request a uniform resource locator (URL) address accessible by the mobile hardware device 500 to convey the protected health information, or subset(s) thereof, from the remote server 800. Similarly, when there is a voice communication connection available, the software application can place a call requesting the protected health information, or subset(s) thereof. As would be appreciated by one of skill in the art, the software application may place the call automatically or may require an indication by the user to place the call. In accordance with example embodiments, if it is unclear which mode of communication is best suited, the software application may perform the requests over both the data and voice communications.

In response to receiving the data message request from the mobile hardware device 500, the remote server 800 can look up the appropriate subset of protected health information (e.g., emergency response health information). In accordance with example embodiments, the remote server may use the unique patient identification string 740 to look up the associated protected health information in the database 760. For example, the remote server 800 may compare the unique patient identification string 740 to a lookup table in the database 760 and locate the associated protected health information identified by the lookup table. The resulting protected health information may be transmitted from the database 760 to the remote server 800 for additional processing. In accordance with example embodiments, the remote server 800 may determine which subset of the protected health information should be shared with the user. For example, the remote server may be configured to determine that the source of the request is from a mobile hardware device 500 outside a secure hospital network and select the emergency response health information subset of the protected health information.

In accordance with example embodiments, the resulting subset of the protected health information may be included in a data message to be transmitted to the mobile hardware device 500. As would be appreciated by one of skill in the art, the subset of the protected health information may be presented to the mobile hardware device 500 as a text message, an audio message (e.g., via telephone call), a hyperlink for a webpage to be loaded in a browser, or a combination thereof. Advantageously, the remote server 800 may determine the most reliable communication channel to reach the mobile hardware device 500 and transmit the subset of the protected health information over that channel. Once the protected health information or hyperlink for displaying the protected health information is received, the software application may cause the mobile hardware device 500 to automatically display the subset of the protected health information, or load the hyperlink for displaying the subset of the protected health information. In accordance with example embodiments, the remote server 800 may create a URL webpage with the subset of the protected health information when a URL for that particular subset of the protected health information does not exist at the time of the request.

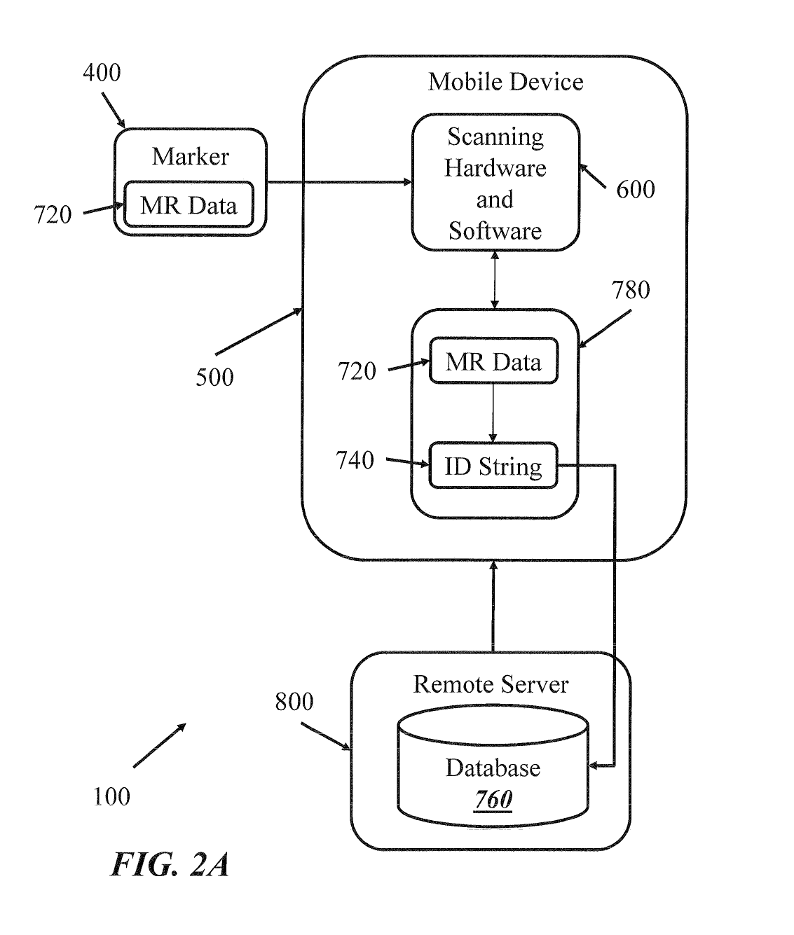

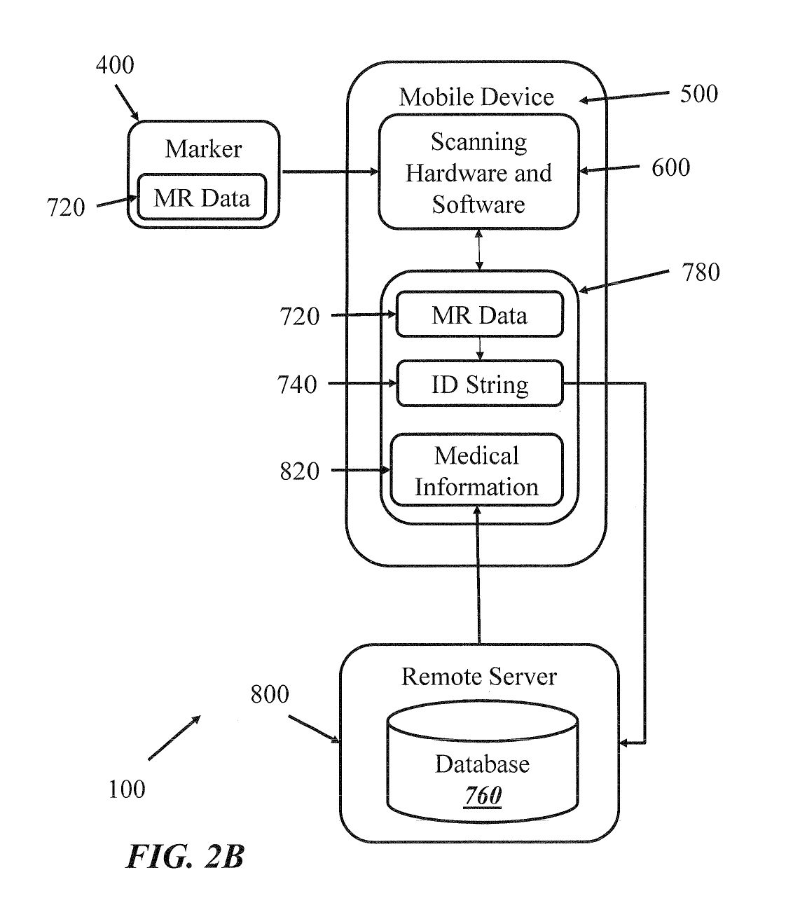

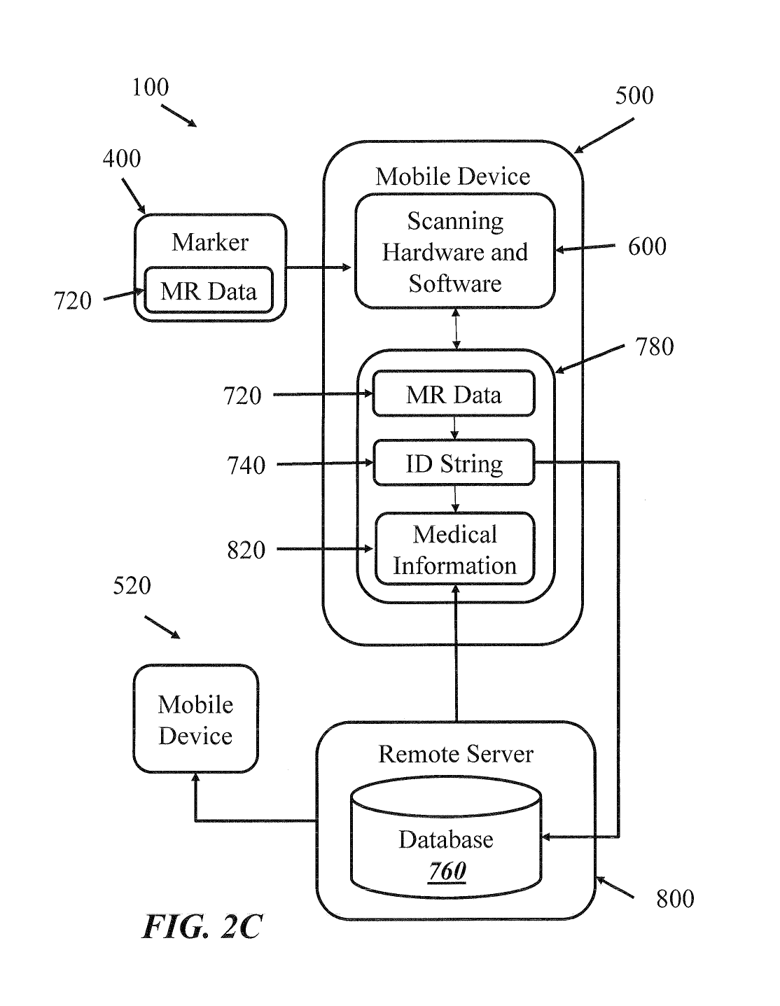

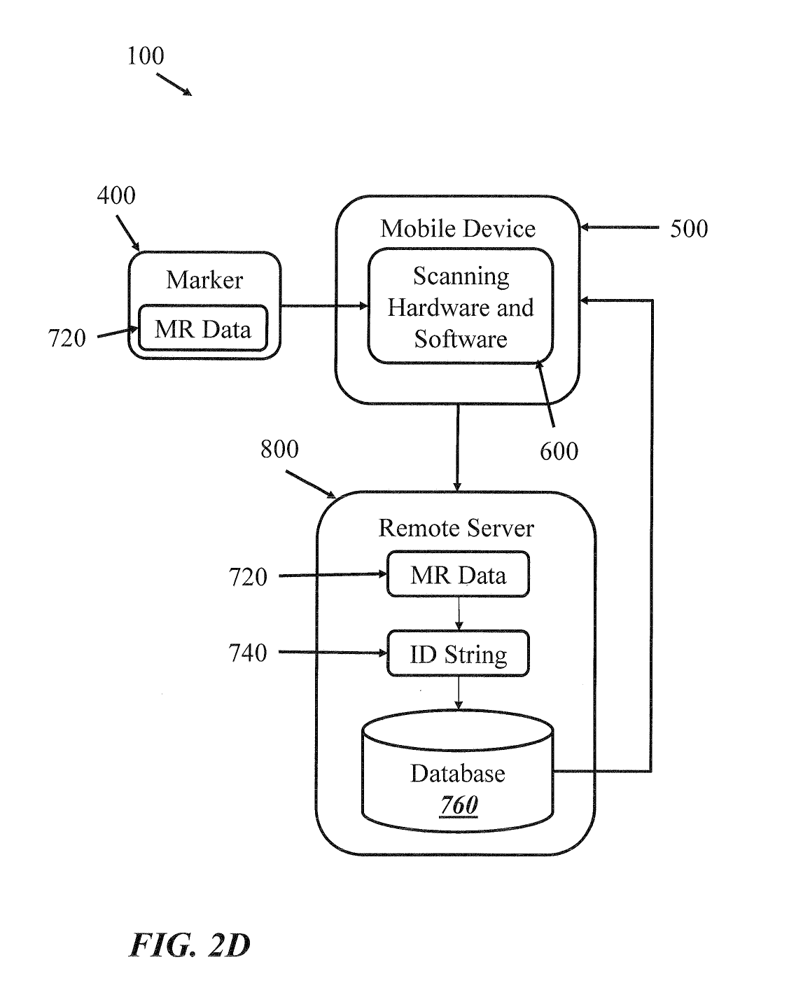

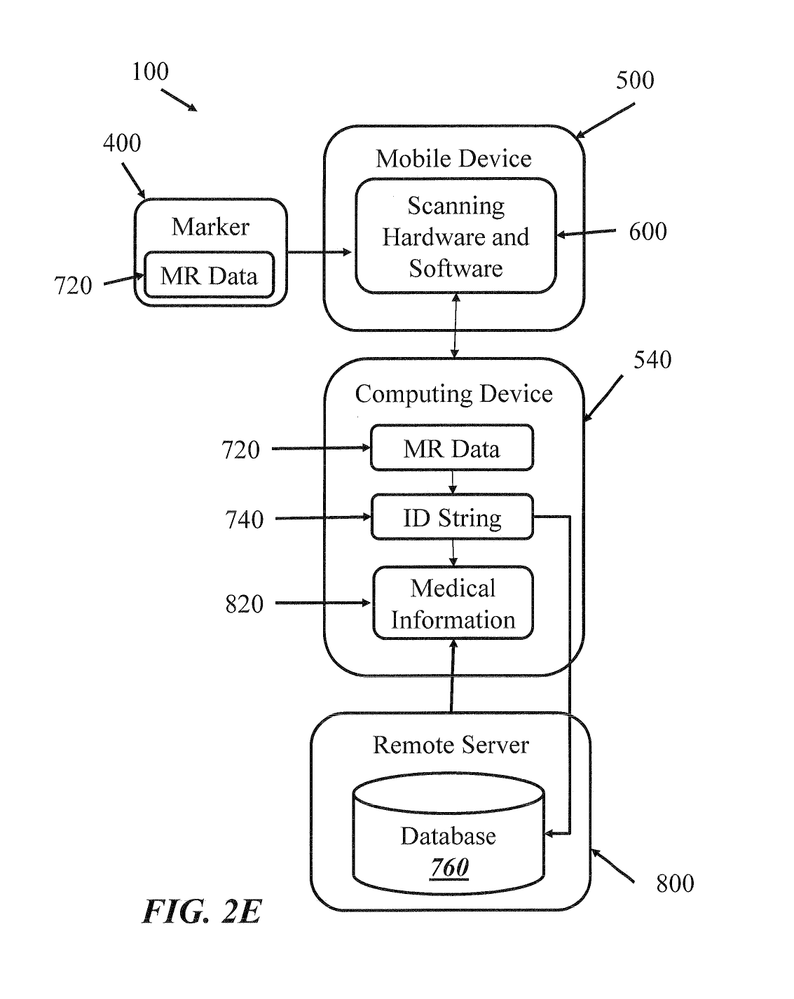

FIGS. 2A-2D provide diagrammatic illustrations of methods for conveying patient-specific emergency response health information to an emergency responder, according to example embodiments of the present invention. Although the present invention will be described with reference to the example embodiment or embodiments illustrated in the figures, it should be understood that many alternative forms can embody the present invention. Similarly, any combination of the example embodiments may be used in combination without deviating from the present invention. One of skill in the art will additionally appreciate different ways to alter the parameters of the embodiment(s) disclosed, in a manner still in keeping with the spirit and scope of the present invention. For example, FIGS. 2A-2D reference the use of the mobile hardware device 500, however the present invention is not intended to be limited to the use of a mobile hardware device. Accordingly, the example embodiments disclosed may be used in conjunction with other computing systems (e.g., a desktop computer) without deviating from the spirit and scope of the present invention.

In accordance with an example embodiment of the present invention, FIG. 2A illustrates a method of communicating protected health information from the marker 400 of a patient to the mobile hardware device 500. The marker 400 that is physically held by or connected to the patient includes machine-readable data 720. The marker 400 may be operable to convey, transmit, or otherwise communicate the machine-readable data 720 to a user (e.g., emergency responder) providing assistance to the patient. For example, the user may utilize the scanning hardware and software 600 on the mobile hardware device 500 to capture, transform, and store the machine-readable data 720 on the mobile hardware device 500. Once the machine-readable data 720 is captured by the scanning hardware and software 600 is stored within the memory 780 resident on the mobile hardware device 500. For example, mobile hardware device 500 receives the machine-readable data 720 by scanning the marker 400, using the scanning hardware and software 600 transforms the machine-readable data 720 into a unique patient identification string 740, and stores the unique patient identification string 740 locally in memory. Accordingly, the mobile hardware device 500 is configured to use a combination of hardware and software (e.g., scanning hardware and software 600) to transform data (e.g., machine-readable data 720) obtained from the marker 400 in a manner consistent with the particular objectives (e.g., obtaining emergency response health information) of the present invention. As would be appreciated by one of skill in the art, the unique patient identification string 740 can be stored in an encrypted format, for example when transformed from machine readable data 720 displayed as plain text on marker 400, and/or the unique patient identification string 740 can include an alpha-numeric string.

Continuing with FIG. 2A, after scanning the marker 400 and transforming the machine-readable data 720 into the unique patient identification string 740, the mobile hardware device 500 initiates an outgoing data message to the remote server 800, including the unique patient identification string 740. As would be appreciated by one of skill in the art, the outgoing data message may be transmitted over any telecommunication network(s) 700 available to the mobile hardware device 500. For example, the mobile hardware device 500 can initiate and output a data message (e.g., SMS or email) containing the unique patient identification string 740 and additional information (e.g., spoken language preference) using an open and active communication channel to a remote server 800 configured to receive the data message. In response to outputting the data message, the mobile hardware device 500 receives an incoming data message, telephone call, or a combination thereof, from the remote server 800. The incoming data message, telephone call, or combination thereof and contains the appropriate subset of the protected health information (e.g., the emergency response health information subset) associated with the unique patient identification string 740.

According to aspects of the present invention, the incoming data messages may be used by the mobile hardware device 500 to display the emergency response health information, provision of a record number required for obtaining additional protected health information from another source, and/or provision of a clickable hyperlink to the emergency response health information. According to aspects of the present invention, a portion or portion(s) of the incoming data message is conveyed to the user via at least one conveyance interface such as via on screen information displayed visually on a screen and/or computer read out aloud such as computer “vocalizations” through the speakers of the mobile hardware device 500. According to aspects of the present invention, the incoming data message, telephone call, or combination thereof, can further include a uniform resource locator (URL) address accessible by the mobile hardware device 500 to obtain the subset of the emergency response health information. The incoming data message, telephone call, or combination thereof can be received by a second mobile hardware device 520. Advantageously, lie incoming data message, telephone call, or combination thereof, may be implemented in the preferred spoken natural language indicated by the software application and/or the mobile hardware device 500. For example, the software application on the mobile hardware device 500 can include an indication of a preferred spoken language in the outgoing data message and the remote server 800 may use the spoken language indication when generating the incoming data message. For example, the software application on the mobile hardware device can be updated with an indication of a preferred spoken language for the mobile hardware device 500. Accordingly, any response received from the remote server 800 will be generated in the preferred spoken language indicated by the mobile hardware device 500.

In accordance with an example embodiment of the present invention, FIG. 2B illustrates a method of communicating emergency response health information 820 of a patient from the remote server 800 to the mobile hardware device 500. The remote server 800 receives the data message requesting emergency response health information 820 containing the unique patient identification string 740 from the mobile hardware device 500, as discussed with respect to FIG. 2A. In response to the request, the remote server 800 accesses the database 760 that stores the unique patient identification string 740 and the associated emergency response health information 820. As would be appreciated by one of skill in the art, the database 760 may be part of the remote server 800 or may be located remotely to the remote server 800. The emergency response health information 820, which can be associated with the unique patient identification string 740, can be included within one or more databases 760. The remote server 800 looks up and obtains the emergency response health information 820 associated with the unique patient identification string 740 from the database 760. For example, the remote server 800 uses a lookup table to find the protected health information associated with the unique patient identification string 740. As would be appreciated to one of skill in the art, the lookup may be performed using any method known in the art (e.g., using a hash table).

In accordance with example embodiments, the remote server 800 may also determine which subset(s) of the protected health information the user is allowed to access and/or is requesting. For example, the remote server 800 may determine that the user is an emergency responder and that the user is only authorized to access the emergency response health information subset. Alternatively, in the event that the user is a doctor in a hospital and requests access to the full patient medical information, the remote server 800 may request additional authorization. For example, the remote server 800 may request a unique PIN or other authentication and/or authorization be provided by the patient associated with the patient medical information. Thereafter, the remote server 800 automatically outputs a data message, a telephone call, or combination thereof containing the appropriate subset of the protected health information associated with the unique patient identification string 740, to the mobile hardware device 500. For example, the automated system may generate and use the mobile phone number of the mobile hardware device 500 to send data messages to the mobile hardware device 500. In accordance with example embodiments, the machine-readable data 720, the unique patient identification string 740, the received subset of the protected health information (via the incoming data message from the remote server as discussed with respect to FIG. 2A) are stored in memory 780, resident on the mobile hardware device 500. As would be appreciated by one of skill in the art, the protected health information may be stored in the memory 780 only temporarily, and may be periodically purged to protect the patient's protected health information.

FIG. 2C illustrates aspects of an embodiment of the present invention of how the software application stored and executing on the mobile hardware device 500 is utilized to share the emergency response health information 820 with a second mobile hardware device 520. In particular, FIG. 2C depicts how emergency response health information 820 may be shared with a second mobile hardware device 520 other than the mobile hardware device 500 scanning the marker 400. The scanning hardware and software 600, for the mobile hardware device 500, scans, receives, or otherwise obtains the machine-readable data 720 from the marker 400. The mobile hardware device 500 stores, analyzes, and transforms the machine-readable data 720 into a unique patient identification string 740. The software application initiates and places the unique patient identification string 740 in memory 780 and outputs the unique patient identification string 740 in an outgoing data message addressed to the remote server 800. As would be appreciated by one of skill in the art, the outgoing data message is sent to the remote server 800, including the emergency response health information 820 associated with the unique patient identification string 740, as discussed with respect to FIGS. 2A and 2B. In accordance with an embodiment of the present invention, the outgoing data message can include a request for emergency response health information which further comprises an instruction to send the emergency response health information to a second hardware mobile device 520.

In response to the outgoing data message, the second mobile hardware device 520 receives an automatically generated incoming message, such as an incoming data message, telephone call, or combination thereof based on the unique patient identification string 740, As would be appreciated by one of skill in the art, the second mobile hardware device can belong to the patient, to proximal or distal medical personnel, or to other individuals. Alternatively, in accordance with example embodiments, the second mobile hardware device 520 may be specified in the database 760 associated with the unique patient identification string 740. Additionally, the signal type and/or mode of transmitting the machine-readable data 720, the unique patient identification string 740 and/or the database 760 data (for example a call, text, email and/or other communication signal type and/or mode) is automatically determined. The incoming data message contains the emergency response health information 820 associated with the unique patient identification string 740. Accordingly, the second mobile hardware device 520 receives the automatically generated incoming message based on the patient medical profile (e.g., the patient medical profile including the protected health information subsets previously saved by the patient as the emergency response health information) associated with the unique patient identification string 740 in the database 760.

FIG. 2D illustrates aspects of an embodiment of the present invention in which the processing, transforming, and storing of the machine-readable data 720 scanned from the marker 400 are performed by the remote server 800. The mobile hardware device 500 scans, receives, or otherwise obtains the machine-readable data 720 from the marker 400. The machine-readable data 720 is sent to the remote server 800 in an outgoing data message. For example, the software application on the mobile hardware device 500 generates and places the machine-readable data 720 into an outgoing data message addressed to the remote server 800. The remote server 800 receives the machine-readable data 720 and transforms the machine-readable data 720 into a unique patient identification string 740. Thereafter, the remote server 800 uses the unique patient identification string 740 to lookup the emergency response health information associated with the unique patient identification string 740 from the database 760, as discussed with respect to FIGS. 2A-2C. The remote server 800 transmits an automatically generated data message to the mobile hardware device 500, in the form of a data message, telephone call, or combination thereof, including the emergency response health information associated with the unique patient identification string 740. Accordingly, the remote server 800 automatically processes the received machine-readable data 720 and transmits the emergency response health information to the mobile hardware device 500, as determined from the machine-readable data 720. According to aspects of the present invention, the remote server 800 is operated and/or maintained by a service provider to provide access to the patient records stored within database 760.

FIG. 2E illustrates aspects of an embodiment of the present invention in which the processing, transforming, and storing of the machine-readable data 720 scanned from the marker 400 are performed by a computing device 540 (e.g., a desktop computer) other than the mobile hardware device 500. For example, the computing device 540 may be a desktop computer in a doctor's office at a hospital connected through the hospital's secure network. In operation, the mobile hardware device 500 scans, receives, or otherwise obtains the machine-readable data 720 from the marker 400. The machine-readable data 720 is sent from the mobile hardware device 500 to the computing device 540 in an outgoing data message. For example, the software application on the mobile hardware device 500 generates and places the machine-readable data 720 into an outgoing data message addressed to the computing device 540. The computing device 540 receives the machine-readable data 720 and subsequently transforms the machine-readable data 720 into a unique patient identification string 740. The software application on the computing device 540 initiates and places the unique patient identification string 740 in memory and outputs the unique patient identification string 740 in an outgoing data message addressed to the remote server 800. Additionally, the computing device 540 may include a request the patient medical information in the outgoing data message. For example, the computing device 540 may be used by the doctor to request the patient medical information. As would be appreciated by one of skill in the art, the outgoing data message is sent to the remote server 800 including the patient medical information associated with the unique patient identification string 740, as discussed with respect to FIGS. 2A-2D.

Continuing with FIG. 2E, the remote server 800 uses the unique patient identification string 740 to lookup the patient medical information associated with the unique patient identification string 740 from the database 760, as discussed with respect to FIGS. 2A-2D. As would be appreciated by one of skill in the art, the remote server 800 may determine whether access to the patient medical information requires additional authorization. For example, the remote server 800 may request authorization from the patient to permit access to the patient medical information, unlike for the emergency response health information. Alternatively, the computer requesting access can be on a pre-authorized list (i.e., the patient may have pre-authorized their doctor's office as having authorization to access the protected health information). Once authorization, if necessary, has been received, the remote server 800 transmits an automatically generated data message to the mobile hardware device 500 and/or the computing device 540 including the requested patient medical information associated with the unique patient identification string 740. Accordingly, the remote server 800 automatically processes the received machine-readable data 720 and transmits the patient medical information to the mobile hardware device 500 and/or the computing device 540, as determined from the machine-readable data 720. According to aspects of the present invention, the remote server 800 is operated and/or maintained by a service provider to provide access to the patient records stored within database 760.

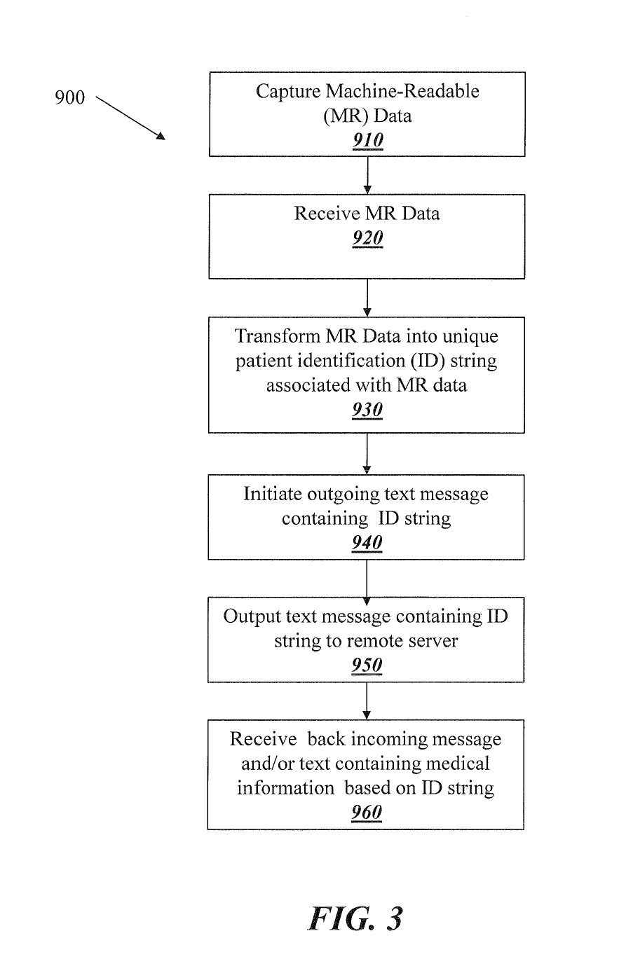

FIG. 3 provides a flow chart illustrating a method 900 by which the mobile hardware device 500 communicates the emergency response health information to a user, according to aspects of the present invention. In accordance with an embodiment of the present invention, the scanning hardware and software 600 coupled to a mobile hardware device 500 of a user receives machine-readable data 720 located on marker 400 by, for example, reading and/or capturing the proximal machine-readable data 720 from the marker 400 (step 910). The software application, stored and executing on a processor on the mobile hardware device 500, receives the machine-readable data 720 (step 920) and transforms the machine-readable data 720 into a unique patient identification string 740 (step 930), the unique patient identification string 740 identifying the patient and or the patient's emergency response health information. The software application stored and executing on a processor on the mobile hardware device 500, initiates an outgoing data message, placing the unique patient identification string 740 into the outgoing data message (step 940). The outgoing data message containing the unique patient identification string 740 is output from the mobile hardware device 500 to a remote server 800 (step 950). In response to the outgoing data message containing the unique patient identification string 740, the mobile hardware device 500 receives back from the remote server 800, an automatically generated incoming message, such as a data message, telephone call, or combination thereof, based on the unique patient identification string 740 contained in the outgoing data message (step 960). The data message, telephone call, or combination thereof, contain the emergency response health information associated with the unique patient identification string (step 960).

An exemplary example of a method by which data transformation during communications between the various hardware devices and users is effected, according to an aspect of the present invention. Machine readable data 720 is scanned by a user. According to aspects of the present invention, if the machine readable data 720 is a machine-readable code then a URL linking the user to patient information is loaded into a browser. According to aspects of the present invention, if the machine readable data 720 is an NFC code and if a first data connection is verified then a URL linking the user to patient information is loaded into the browser. If a first data connection is not verified then the request for accessing the URL linking the user to patient information is sent via SMS and a call is received by the user from a remote server 800, the call delivering in audible form the URL and/or information contained in the patient information profile linked to the URL.

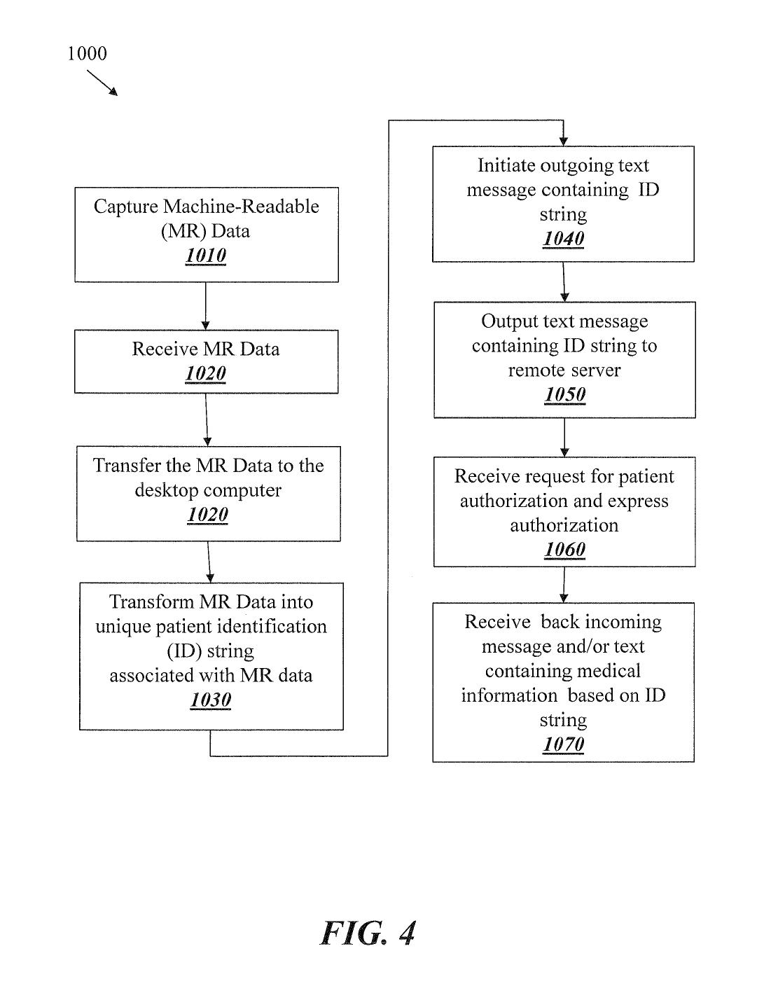

FIG. 4 provides a flow chart illustrating a method 1000 by which the marker 400 is used to provide access to patient medical information upon execution of an additional authentication and/or authorization step by the patient. For example, the machine-readable data 720 from the marker 400 may be used in a doctor's office on a secure network to access the patient medical information, which may require authentication/authorization from the patient. In accordance with an embodiment of the present invention, the scanning hardware and software 600 coupled to the mobile hardware device 500 obtains machine-readable data 720 located on marker 400 by reading and/or capturing the proximal machine-readable data 720 from the marker 400 (step 1010). As would be appreciated by one of skill in the art, the mobile computing device 500 may be used in conjunction with the computing device 540. For example, the hardware mobile device 500 may be a handheld scanning device used to scan the marker 400 and transfer the machine-readable data 720 to the desktop computing device 540 (step 1020), as discussed with respect to FIG. 2E.

The software application, stored and executing on a processor on the computing device 540, receives the machine-readable data 720 and transforms the machine-readable data 720 into a unique patient identification string 740 (step 1030), the unique patient identification string 740 identifying the patient and/or the patient medical information. The software application stored and executing on a processor on the computing device 540, initiates an outgoing data message, placing the unique patient identification string 740 into the outgoing data message (step 1040). The outgoing data message containing the unique patient identification string 740 is output from the computing device 540 to a remote server 800 (step 1050). Additionally, the outgoing data message may include a request for a particular subset of the protected health information (e.g., patient identification information). As would be appreciated by one of skill in the art, the patient medical information may be protected by HIPPA and other privacy laws, such that access to this information may be limited to authorized personnel. In response to the outgoing data message containing the unique patient identification string 740, the computing device 540 receives back from the remote server 800 a request for authorization (step 1060).

As would be appreciated by one of skill in the art, when requesting the patient medical information the remote server 800 will require additional authentication and/or authorization of the patient associated with the patient medical information. For example, the remote server 800 may request a patient password or personal identification number (PIN) prior to providing the computing device 540 with the patient medical information. The computing device 540 may receive the authorization from the patient and transmit the authorization (e.g., PIN) to the remote server 800 (step 1060). Once the proper authorization is received and verified by the remote server 800, the computing device 540 may receive an automatically generated incoming message, such as a data message, email, and/or URL, based on the unique patient identification string 740 contained in the outgoing data message (step 1070). The data message, email, and/or URL may contain the patient medical information associated with the unique patient identification string (step 1070).

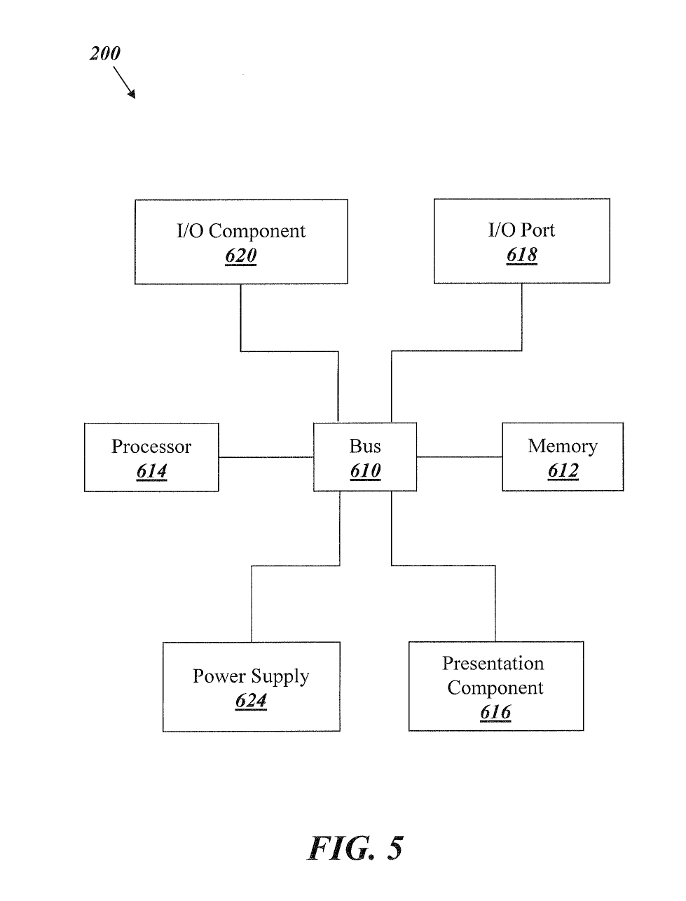

Any suitable computing device can be used to implement the computing devices 500, 520, 540 and methods/functionality described herein. One illustrative example of such a computing device 200 is depicted in FIG. 5. The computing device 200 is merely an illustrative example of a suitable computing environment and in no way limits the scope of the present invention. A “computing device,” as represented by FIG. 5, can include a “workstation,” a “server,” a “laptop,” a “desktop,” a “hand-held device,” a “mobile device,” a “tablet computer,” or other computing devices, as would be understood by those of skill in the art. Given that the computing device 200 is depicted for illustrative purposes, embodiments of the present invention may utilize any number of computing devices 200 in any number of different ways to implement a single embodiment of the present invention. Accordingly, embodiments of the present invention are not limited to a single computing device 200, as would be appreciated by one with skill in the art, nor are they limited to a single type of implementation or configuration of the example computing device 200.

The computing device 200 can include a bus 610 that can be coupled to one or more of the following illustrative components, directly or indirectly: a memory 612, one or more processors 614, one or more presentation components 616, input/output ports 618, input/output components 620, and a power supply 624. One of skill in the art will appreciate that the bus 610 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 5 is merely illustrative of an exemplary computing device that can be used to implement one or more embodiments of the present invention, and in no way limits the invention.

The computing device 200 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 200.

The memory 612 can include computer-storage media in the form of volatile and/or nonvolatile memory. The memory 612 may be removable, non-removable, or any combination thereof. Exemplary hardware devices are devices such as hard drives, solid-state memory, optical-disc drives, and the like. The computing device 200 can include one or more processors that read data from components such as the memory 612, the various I/O components 616, etc. Presentation component(s) 616 present data indications to a user or other device. Exemplary presentation components include a display device, speaker, printing component, vibrating component, etc.

The I/O ports 618 can enable the computing device 200 to be logically coupled to other devices, such as I/O components 620. Some of the I/O components 620 can be built into the computing device 200. Examples of such I/O components 620 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method of communicating a first subset of protected health information selected from protected health information of a patient to a mobile hardware device, the method comprising:
a user utilizing a scanning hardware and software of the mobile hardware device to capture a machine-readable data from a marker;
an application stored and executing on the mobile hardware device, the application receiving the machine-readable data from the marker and transforming the machine-readable data into a unique patient identification string associated with the machine-readable data;
the application initiating an outgoing text message and placing the unique patient identification string into the outgoing text message;
the outgoing text message outputting from the mobile hardware device to a remote server; and
the mobile hardware device receiving back an automatically generated incoming text message, telephone call, or both, based on the unique patient identification string contained in the outgoing text message;
wherein the incoming text message, telephone call, or both, contain the first subset of protected health information associated with the unique patient identification string;
wherein the protected health information comprises emergency response health information, patient identification information, and patient medical information;
wherein the first subset of protected health information comprises emergency response health information, patient identification information, or both;
wherein a second subset of protected health information comprises patient medical information; and
wherein the method is completed without requiring real-time active authorization from the patient.

2. The method of claim 1, wherein the application receives information from the mobile hardware device indicating whether there is a cellular communication signal, a Wi-Fi signal, a Miracast signal, a data connection, or combinations thereof.

3. The method of claim 1, wherein when there is a data connection available, the application includes in the outgoing text message a request for a uniform resource locator (URL) address accessible by the mobile hardware device to convey the first subset of protected health information.

4. The method of claim 1, wherein when there is no data connection available, the application includes in the outgoing text message a request for a text message, a telephone call, or both.

5. The method of claim 1, wherein the application is updated with information indicating a preferred spoken language setting for the mobile hardware device.

6. The method of claim 1, wherein the application includes in the outgoing text message an indication of a preferred spoken natural language.

7. The method of claim 1, wherein the incoming text message, telephone call, or both, are implemented in a preferred spoken natural language indicated by the application or the mobile hardware device.

8. The method of claim 1, wherein the unique patient identification string comprises an alpha-numeric string.

9. The method of claim 1, wherein the unique patient identification string maintains patient anonymity by not containing a combination of string characters that is perceivable by a human to on-its-face convey patient identifying information, in such a way that the unique patient identification string is non-human readable.

10. The method of claim 1, wherein the machine-readable data is disposed on or in a tattoo, necklace, pendant, or bracelet of the patient.

11. The method of claim 1, wherein the machine-readable data is disposed on or in a bracelet, a capsule, a tag, a band, a wallet identification card, a medical an identification card, or another wearable and/or injectable article of the patient.

12. The method of claim 1, wherein the machine-readable data is stored in an injectable NFC capsule or a microchip.

13. The method of claim 1, wherein the incoming text message further comprises a uniform resource locator (URL) address accessible by the mobile hardware device to obtain the first subset of protected health information.

14. The method of claim 1, further comprising the incoming text message, telephone call, or both, being received by a second mobile hardware device.

15. The method of claim 1, wherein the scanning hardware and software comprises one or more of an optical scanning device, an optical reader, a pen-type reader, a laser scanner, a charge-couple device (CCD) reader, a camera-based reader, a large field-of-view reader, an omni-directional bar code data scanner, a cellular telephone camera, a smartphone, a near field communication (NFC) reader, a radio frequency identification (RFID) reader, and/or combinations thereof.

16. The method of claim 1, wherein the machine-readable data comprises one or more of characters, symbols, images, patterns, radio frequency transmitted data including RFID and NFC transmitted data, and/or combinations thereof.

17. The method of claim 1, wherein the first subset of protected health information associated with the unique patient identification string comprises one or more databases that stores the first subset of protected health information linked with the unique patient identification string, and wherein providing the one or more databases with the unique patient identification string results in presentation of the first subset of protected health information.

18. The method of claim 17, wherein presentation of the first subset of protected health information comprises one or more of a display of the first subset of protected health information, provision of a record number required for obtaining the first subset of protected health information from another source, or provision of a clickable hyperlink to the first subset of protected health information.

19. The method of claim 1, wherein the machine-readable data comprises one or more of a bar code, a quick response (QR) code, a matrix code, a plurality of symbols, an image code, an optically scannable code, data conveyed by near field communication, data conveyed by radio frequency, and/or combinations thereof.

20. The method of claim 1, wherein the outgoing text message comprises an instruction to send the first subset of protected health information to a second device.

21. The method of claim 1, wherein the unique patient identification string is stored in an encrypted format, and wherein a database that stores the unique patient identification string is encrypted with 256-bit advanced encryption standard (AES) encryption.

22. A method of communicating protected health information of a patient, the method comprising:
a server receiving a request for protected health information comprising a first subset of protected health information or a second subset of protected information, the request containing a unique patient identification string, wherein the protected health information comprises emergency response health information, patient identification information, and patient medical information, the first subset of protected health information comprises the emergency response health information, the patient identification information, or both, and the second subset of protected information comprises the patient medical information;
the server accessing a database that stores the unique patient identification string in association with the protected health information;
the server obtaining the protected health information stored in association with the unique patient identification string;
the server determining which subset of the protected health information is requested; and
the server causing the automated outputting of a text message, a telephone call, or both, containing the first subset of protected health information associated with the unique patient identification string, or the server receiving patient authorization and outputting data containing the second subset of protected health information.

23. The method of claim 22, wherein the request for protected health information further comprises a request for a uniform resource locator (URL) address accessible to convey the protected health information.

24. The method of claim 22, wherein the request for protected health information further comprises an indication of a preferred spoken language setting for conveyance of the protected health information.

25. The method of claim 22, wherein the text message, the telephone call, or both, are implemented in a preferred spoken natural language indicated by the request for protected health information.

26. The method of claim 22, wherein the unique patient identification string comprises an alpha-numeric string.

27. The method of claim 22, wherein the unique patient identification string maintains patient anonymity by not containing a combination of string characters that is perceivable by a human to on-its-face convey patient identifying information, in such a way that the unique patient identification string is non-human readable.

28. The method of claim 22, wherein the request for protected health information comprises a uniform resource locator (URL) address accessible by a mobile hardware device to obtain the protected health information.

29. The method of claim 22, wherein the request for protected health information comprises an instruction to send the protected health information to a second device.

30. The method of claim 22, wherein the database is encrypted with 256-bit advanced encryption standard (AES) encryption.

31. The method of claim 22, wherein the database that stores the unique patient identification string in association with the protected health information comprises one or more databases that store protected health information linked with the unique patient identification string, and wherein providing the one or more databases with the unique patient identification string results in presentation of the first subset of protected health information or the second subset of protected health information.

32. The method of claim 31, wherein presentation of the first subset of protected health information or the second subset of protected health information comprises one or more of a display of protected health information, provision of a record number required for obtaining protected health information from another source, or provision of a clickable hyperlink to protected health information.

33. The method of claim 22, wherein the determining which subset of the protected health information is requested further comprises determining a level of authorization needed to access the second subset of protected health information.

34. The method of claim 33, wherein the level of authorization for the second subset of patient medical information requires real time authorization from the patient.

35. The method of claim 34, further comprises:
sending a request for authorization for access to the second subset of protected health information to the patient;
receiving the authorization from the patient for access to the second subset of protected health information; and
granting access to the second subset of protected health information.

36. The method of claim 35, wherein the authorization comprises receipt of at least one of a password and a personal identification number (PIN).
